(19) United States
(12) Patent Application Publication
(10) Pub. No.: US 2005/0287890 A1
(43) Pub. Date: Dec. 29, 2005

(54) CLADDING ELEMENT FOR A VEHICLE

(75) Inventors: Michael Herrmann, Leverkusen (DE); Kai-Uwe Lichi, Koeln-Dellbrueck (DE)

Correspondence Address: KEVIN G. MIERZWA;ARTZ & ARTZ, P.C., 28333 TELEGRAPH ROAD, SUITE 250, SOUTHFIELD, MI, 48034, US

(73) Assignee: Ford Motor Company, Dearborn, MI (US)

(21) Appl. No.: 11/160,475

(22) Filed: Jun. 24, 2005

(30) Foreign Application Priority Data
Jun. 25, 2004 (EP) 04102978.6

(51) Int. Cl. B32B 15/04; B32B 15/01; B32B 27/36

(52) U.S. Cl. 442/6; 442/229; 442/286; 442/287; 442/290; 442/291; 442/293; 442/16

(57) ABSTRACT

A layered cladding element for a vehicle. The layered cladding element includes a first layer (1) and a second layer (7) adjacent to the first layer (1). The first layer (1) is comprised of a fiber textile with an external surface (1′) and an internal surface (1″). The external surface (1′) has an uncovered texture for providing a predetermined view and feel. Moreover, the internal surface (1″) has the second layer (7) adjacent thereto, which is comprised of plastic.

### CROSS-REFERENCE TO RELATED APPLICATION

This application claims the benefit of EP Application No. 041 02978.6, filed with the European Patent Office on Jun. 25, 2004, entitled “CLADDING ELEMENT FOR A VEHICLE,” and is incorporated by reference herein.

### TECHNICAL FIELD

The present invention relates generally to vehicles, and more particularly to a layered cladding element for a vehicle.

### BACKGROUND OF THE INVENTION

Cladding elements for vehicles typically provide protective coverings and/or designs. For instance, dashboards in existing vehicles are utilized for covering the internal workings of instrument clusters and are produced in a variety of designs. By way of another example, ground effects or other bodywork have been installed on the exterior of certain vehicles. It is understood that existing cladding elements typically have a flat, non-textured surface.

WO 94/13497 A1 discloses a decorative element comprised of a transparent layer with a thin fiber sub-layer completely embedded therein. In other words, the fiber sub-layer is completely encased within the transparent layer. Accordingly, the transparent layer has a flat, non-textured surface that provides a somewhat protective covering for the fiber sub-layer therein. However, these decorative elements do not have a substantially strong construction because they are not cladding elements themselves but rather are applied to and supported by cladding elements.

It would therefore be desirable to provide a layered cladding element having a textured surface and a substantially strong construction for use in a vehicle.

### SUMMARY OF THE INVENTION

One advantage of the invention is that a layered cladding element for a vehicle is provided that has a substantially strong construction suitable for use in a vehicle.

Another advantage of the invention is that a layered cladding element for a vehicle is provided that is substantially lightweight for increasing the fuel economy and the overall performance of the vehicle.

Yet another advantage of the invention is that a layered cladding element for a vehicle is provided that enhances the visual and tactile appeal of the vehicle.

Still another advantage of the invention is that a layered cladding element for a vehicle is provided that is comprised of sufficiently stiff material for enhancing the manufacture of the cladding element.

In accordance with the above and other advantages of the invention, a layered cladding element for a vehicle is provided. The layered cladding element includes a first layer and a second layer adjacent to the first layer. The first layer is comprised of a fiber textile with an external surface and an internal surface. The external surface has an uncovered texture for providing a predetermined view and feel. Moreover, the internal surface has the second layer adjacent thereto, which is comprised of plastic.

Other features, properties, and advantages of the invention are apparent from the following description of the drawing.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a perspective view of a stamped-out pre-form comprised of fiber textile for the production of a first layer of a layered cladding element, according to one embodiment of the present invention;

FIG. 2 is a perspective view of the stamped-out pre-form shown in FIG. 1 after a machining process;

FIG. 3 is a perspective view of the stamped-out pre-form shown in FIG. 2 after an additional machining processes;

FIG. 4A is a cross sectional view of the stamped-out pre-form shown in FIG. 3 after applying a protective foil to the fiber textile;

FIG. 4B is a cross-sectional view of the stamped-out pre-form shown in FIG. 3 after applying a support layer to the fiber textile;

FIG. 5A is a cross-sectional view of the stamped-out pre-form shown in FIG. 4A after applying a second layer to the protective foil;

FIG. 5B is a cross-sectional view of the stamped-out pre-form shown in FIG. 4B after applying a second layer to the support layer; and

FIG. 6 is a perspective cross-sectional view of the layered cladding element manufactured in accordance with the method exemplified in FIGS. 1 through 5B, according to one advantageous embodiment of the claimed invention.

Still other advantages and features of the present invention will become apparent from the following detailed description considered in conjunction with the accompanying drawings. It is understood, however, that the drawings are designed solely for purposes of illustration and not as a definition of the limits of the invention, for which reference should be made to the appended claims. It is further understood that the drawings are not necessarily drawn to scale and that, unless otherwise indicated, they are merely intended to conceptually illustrate the structures and procedures described herein.

### DETAILED DESCRIPTION OF THE INVENTION

In the following figures, the same reference numerals are used to identify the same components in the various views.

The present invention is particularly suited for use in a vehicle. However, it is contemplated that the invention can be carried out in a variety of other modes and utilized for other suitable applications as desired.

Preferably, the layered cladding element is integrated within the interior of a vehicle and covers an entire region therein, such as the dashboard or the center console. However, it is contemplated that the cladding element can instead only cover a relatively small section, e.g. a window surround, of the vehicle interior or exterior.

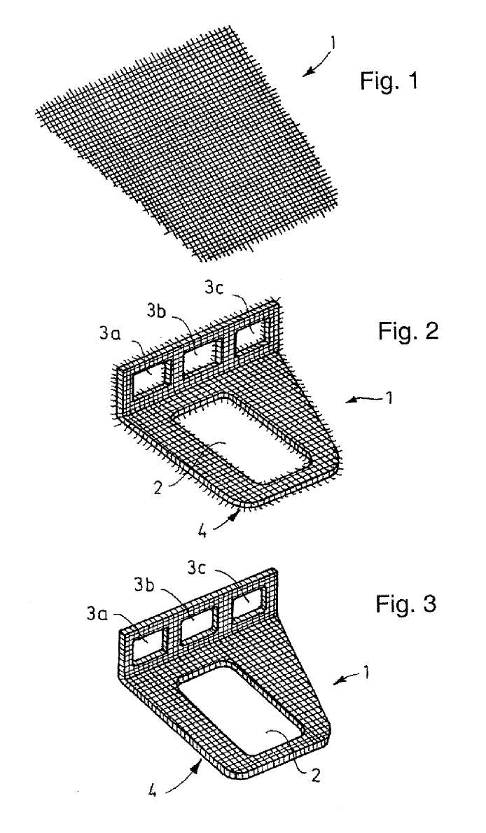

As introduced hereinabove, FIGS. 1 through 5B sequentially illustrate the steps of manufacturing a layered cladding element, according to two or more advantageous embodiments of the claimed invention. FIG. 6 is a perspective cross-sectional view of the layered cladding element produced according to the method exemplified in FIGS. 1 through 5B.

With specific attention to FIG. 6, the layered cladding element includes a first layer 1 and a second layer 7 adjacent to the first layer 1. The first layer 1 is comprised of a fiber textile with an external surface 1′ and an internal surface 1″. The external surface 1′ has an uncovered texture for providing a predetermined view and feel. Moreover, the internal surface 1″ has the second layer 7 adjacent thereto, which is comprised of plastic.

The fiber textile and the plastic are comprised of suitable materials for providing a two-layered structure having a substantially low weight and high stiffness. In other words, the two-layered structure is comprised of a precise combination of a predetermined fiber textile and a predetermined plastic for providing desired properties of the cladding element. In that regard, the layered cladding element has the desired stiffness, flexibility, weight, fire protection, scratch resistance, and/or other necessary properties for the intended application. For example, a substantially stiff and lightweight cladding element is beneficial for use in vehicles for saving fuel without compromising structural integrity.

As mentioned above, the first layer 1 has an external surface 1′ with an uncovered textured surface thereon for providing a predetermined view and feel. Put another way, the external surface 1′ is uncovered and intended to face toward a user or vehicle occupant. The texture of the external surface 1′ is provided by the woven fiber material of the textile comprising the first outer layer 1. In that regard, the fiber textile is contactable, i.e. not covered. Neither the plastic of the second layer 7 nor any separate outer layer covers the textured external surface 1′.

Accordingly, the first layer 1 is beneficial for providing a visually attractive surface 1′ with an interesting feel. It will also be appreciated that the external surface 1′ can have a suitable texture for use as gripped cladding, e.g. for use on doors.

The fibers of the fiber textile of the first layer 1 preferably have a smooth surface. In that way, the texture of the external surface 1′ has a particularly attractive feel. Either fine-mesh or coarse-mesh textiles may be used as desired.

The fibers preferably consist of only interwoven wires comprised of steel, high-specification steel, aluminum, or an aluminum alloy. This construction is beneficial for providing the external surface 1′ with a desired shiny appearance and an interesting feel. In addition, this construction increases the strength and stiffness of the cladding element while minimizing its weight. However, the fibers can instead be comprised of synthetic wires, other suitable materials, other suitable constructions, or any combination thereof in a variety of colors.

For instance, the fibers of the fiber textile of the first layer 1 may be comprised of other suitable metals. Examples of these metals include iron, iron alloys, metals other than iron, or of any suitable combination thereof.

Furthermore, the fibers can be treated or coated for resisting corrosion or other undesired alteration. Also, the fibers can have a predetermined thickness, a predetermined weight per unit area, and/or a predetermined fiber diameter for its intended use. Preferably, the fibers have a predetermined diameter below one millimeter (e.g. from 0.5 to 0.9 mm), or two or more millimeters (e.g. from 2 to 15 mm).

In another embodiment, the fibers are comprised of a combination of metal fibers and plastic fibers. In yet another embodiment, two textiles are applied in succession with a metal fiber textile and a synthetic textile arranged therebelow.

The second layer 7 is comprised of a plastic material having an exterior facing surface 7′ and an interior facing surface 7″. The exterior facing surface 7′ of the second layer 7 is attached to the internal surface 1″ of the first layer 1. However, as detailed below, the second layer 7 may not be directly attached to the first layer 1 as desired. For instance, the first layer 1 and the second layer 7 can have a protective foil 5 and/or a support layer 6 sandwiched therebetween. The interior-facing surface 7″ of the second layer 7 is directed to a nearby vehicle structure.

The plastic of the second layer 7 can be selected from a wide variety of plastics, as required by the desired property and the intended use of the cladding element.

The cladding element is preferably comprised of an injection-moldable plastic. In particular, the injection—moldable plastic of the second layer 7 is comprised of a polystyrene, a polyamide, a polyurethane, a cellulose ether, a cellulose ester, a polyethylene, a poly(methyl)(meth)acrylic acid, a poly(methyl)(meth)acrylic ester, a rubber, a silicone rubber, a polyphthalate a resin, an epoxy resin, an aminoplastic, a polyolefin, a vinyl polymer, a polyester, an unsaturated polyester, a polyacetal, a polycarbonate, or any copolymer of the above. ABS (acrylonitrile-butadiene-styrene) is preferred for forming the second layer 7.

However, the production of the cladding element is not restricted to injection molding. Other possible means of production include hot press molding, casting, and other suitable manufacturing processes.

In this embodiment, the second layer 7 is comprised of transparent plastic, and the first layer is comprised of a coarse-mesh metal wire textile. In that way, a light-emitting device 8 (shown in FIG. 6) behind the second layer 7 or otherwise adjacent to the cladding element can emit light through the transparent second layer 7 and illuminate the wire mesh of the first layer 1. The light can also pass through the coarse-mesh textile of the second layer 7 and illuminate nearby displays, instruments, and other vehicle devices, or to produce effects.

In order to delimit the rear-illuminated region, there is local delimitation of the transparency of the second layer 7. By way of another example, the light source is focused via a facing so as to prevent light from impacting the second layer except in the delimited location.

In another embodiment, the first layer 1 is a fiber textile comprised of two or more kinds of fiber, including optic fibers. The optic fibers provide interesting effects and/or illuminate displays particularly at night. Also, light sources of different color can, of course, be used for illumination. Further, two or more different fibers may be integrated within the first layer 1 in predetermined patterns or predetermined regions of the fiber textile of the first layer 1.

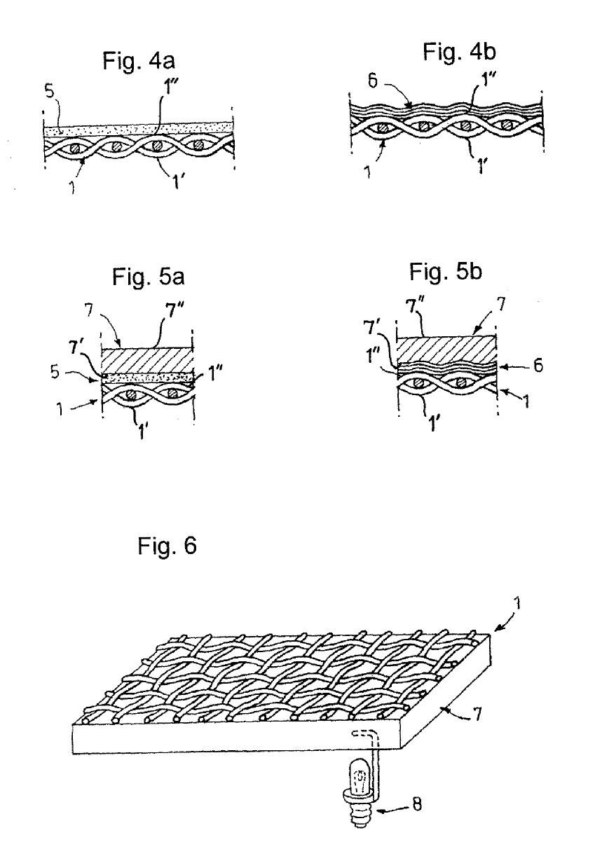

In still another embodiment as shown in FIG. 4A, the first layer 1 and the second layer 7 have a protective foil 5 arranged therebetween. The protective foil 5 inhibits the ingress of plastic of the second layer 7 into the fiber textile of the first layer 1. In this regard, the textile and/or of the plastic can be comprised of various materials in a variety of constructions without the risk of plastic seeping through the fiber textile and covering the external surface 1′. Coarse-mesh textiles are therefore among the materials that can be utilized for the fiber textile. Also, low-viscosity plastics are among those materials that can be utilized for forming the second layer 7.

In yet another embodiment as shown in FIG. 4B, the first layer 1 and the second layer 7 have a support layer 6 arranged therebetween. The support layer 6 also inhibits ingress of the plastic of the second layer 7 into the fiber textile of the first layer 1. In addition, the support layer 6 increases the number of possible combinations of materials and constructions for further tailoring the properties of the cladding element for its intended purpose. By way of example, the structural strength or stiffness of the cladding element can be increased by way of the “sandwich” effect, or other properties can be provided, e.g. improved fire protection or improved sound deadening.

In still another embodiment, the first layer 1 and the second layer 7 have both the protective foil 5 and the support layer 6 arranged therebetween. In this instance, the support layer 6 preferably is adjacent to the first layer 1, and the protective foil 5 preferably is adjacent to the second layer 7. The protective foil 5 and support layer 6 are adhesively bonded or laminated to the internal surface 1 ″ of the fiber textile and/or to one another.

Referring now to FIGS. 1 through 5B, there is sequentially illustrated the steps of a method for manufacturing a layered cladding element exemplified in FIG. 6.

With attention to FIG. 1, a stamped-out pre-form 1 of a generally trapezoidal shape is cut out from a larger mat of fiber textile. The pre-form 1 has the approximate outline of the subsequent cladding element and is comprised of a narrow-mesh fiber textile with fibers comprised of a thin high-specification steel wire. These fibers have a smooth and polished surface forming the first external surface 1′.

In this embodiment, the stamped-out pre-form, namely the fiber textile of the first layer 1, is positioned or otherwise secured by means of a vacuum for eliminating movement and any errors resulting therefrom during the manufacturing process. In another embodiment, the textile includes magnetic fibers and is secured in position by means of magnets.

Referring to FIG. 2, the stamped-out pre-form 1 is provided with a large and generally rectangular hole 2 for the gearshift lever and three smaller rectangular holes 3a, 3b, 3c of equal size for receiving display elements or the like. The holes 3a, 3b, 3c are linearly aligned.

The holes 3a, 3b, 3c may be produced by stamping or cutting. It is understood that a suitable stamping tool can be utilized for producing the holes in the first step.

Further, the stamped-out pre-form 1 is then bent upward by about 90 degrees in the region between the holes 3a, 3b, 3c and the larger hole 2.

Referring to FIG. 3, the cut edges 4 of the stamped-out pre-form 1 are subjected to further machining for removing “frayed” sharp or pointed edges. In that way, the stamped-out pre-form 1 has smooth margins.

Turning now to the embodiment shown FIG. 4A, the protective foil 5 is applied to the internal surface 1″ of the stamped-out pre-form 1 and then receives flowable plastic for forming the second layer 7 thereon. The protective foil 5 inhibits the ingress of the flowable plastic into the fabric textile during the production of the second layer 7. The connection between the protective foil 5 and the internal surface 1″ of the stamped-out pre-form 1 is produced via adhesive bonding or lamination.

Referring now to another embodiment, as shown in FIG. 4B, the support layer 6 is applied to the internal surface 1″ of the stamped-out pre-form 1. The support layer 6 inhibits the ingress of flowable plastic into the fiber textile during the production of the second layer 7. The support layer 6 is attached to the internal surface 1″ of the stamped-out pre-form 1 via adhesive bonding or lamination.

Referring to FIGS. 5A and 5B, preferably black-colored ABS or other suitable flowable plastic is then applied to the protective foil 5 or the support layer 6 by injection molding to form the second layer 7 behind the first layer 1. However, as described above, the plastic can instead be applied directly to the internal surface 1″ of the stamped-out pre-form 1 as desired. Thereafter, the plastic is hardened. It is understood that the ABS may have a predetermined color as desired.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

1. A layered cladding element for a vehicle, comprising:
a first layer comprised of a fiber textile having an uncovered external surface and a covered internal surface;
said uncovered external surface having a texture; and
a second layer adjacent to said covered internal surface of said first layer and comprised of a plastic.

2. The layered cladding element as recited in claim 1, wherein said first layer and said second layer have a protective foil disposed therebetween for separating said plastic from said fiber textile.

3. The layered cladding element as recited in claim 1, wherein said first layer and said second layer have a support layer disposed therebetween for strengthening the layered cladding element.

4. The layered cladding element as recited in claim 1, wherein said first layer and said second layer have a protective foil and a support layer disposed therebetween with said support layer adjacent to said first layer and said protective foil adjacent to said second layer.

5. The layered cladding element as recited in claim 1, wherein said second layer has at least one of a transparent construction and a colored construction.

6. The layered cladding element as recited in claim 1, wherein said fiber textile of said first layer is comprised of a plurality of optic fibers.

7. The layered cladding element as recited in claim 1, wherein said uncovered external surface of said fiber textile has a smooth texture.

8. The layered cladding element as recited in claim 1, wherein said fiber textile of said first layer is comprised of a metal fiber textile.

9. The layered cladding element as recited in claim 8, wherein said fiber textile of said first layer is comprised of a metal wire textile.

10. The layered cladding element as recited in claim 1, wherein said fiber textile of said first layer is comprised of a material selected from the group consisting of an iron, an iron alloy, a metal, and a metal alloy.

11. The layered cladding element as recited in claim 10, wherein said fiber textile of said first layer is comprised of a material selected from the group consisting of a steel, a high-specification steel, a high-strength steel, an aluminum, and an aluminum alloy.

12. The layered cladding element as recited in claim 1, wherein said fiber textile of said first layer is comprised of a construction selected from the group consisting of a plurality of fibers and a plurality of wires, each comprised of a material selected from the group consisting of a metal and a plastic.

13. The layered cladding element as recited in claim 1, wherein said plastic of said second layer is comprised of an injection-moldable plastic.

14. The layered cladding element as recited in claim 13, wherein said injection-moldable plastic of said second layer is comprised of a material selected from the group consisting of a polystyrene, a polyamide, a polyurethane, a cellulose ether, a cellulose ester, a polyethylene, a poly(methyl)-meth)acrylic acid, a poly(methyl)-meth)acrylic acid ester, a rubber, a silicone rubber, a polyphthalate resin, an epoxy resin, an aminoplastic, a polyolefin, a vinyl polymer, a polyester, an unsaturated polyester, a polyacetal, a polycarbonate, and a copolymer of said material.

15. The layered cladding element as recited in claim 13, wherein said injection-moldable plastic of said second layer is comprised of an acrylonitrile-butadiene-styrene.

16. A layered cladding element for a vehicle, comprising:
an external layer comprised of a fiber textile with an outer side and an inner side;
said outer side of said external layer having an uncovered textured surface; and
an internal layer adjacent to said inner side of said external layer and comprised of a plastic.

17. The layered cladding element as recited in claim 16, wherein said internal layer has a transparent construction for transmitting light therethrough from at least one light-emitting device.

18. The layered cladding element as recited in claim 17, wherein said fiber textile is comprised of a plurality of optic fibers for transmitting light therethrough from at least one light-emitting device.

19. A layered cladding element for a vehicle, comprising:
an external layer comprised of a fiber textile with an outer side and an inner side;
said outer side of said external layer having an uncovered textured surface; and
an internal layer comprised of a plastic with an exterior-facing surface and an interior-facing surface;
said exterior-facing surface of said internal layer adjacent to said inner side of said external layer;
said interior-facing surface of said internal layer adjacent to a vehicle structure;
said plastic substantially strong and stiff.

20. The layered cladding element as recited in claim 19, wherein said external layer and said internal layer have a protective foil and a support layer disposed therebetween for separating said plastic from said fiber textile.
